(19) United States
(12) Patent Application Publication
(10) Pub. No.: US 2009/0044762 A1
(43) Pub. Date: Feb. 19, 2009

(54) GRILLE FOR VETERINARY PROCEDURE TABLES

(75) Inventor: Charles C. Keil, Fort Collins, CO (US)

Correspondence Address: WOOD, HERRON & EVANS, LLP, 2700 CAREW TOWER, 441 VINE STREET, CINCINNATI, OH, 45202, US

(73) Assignee: MIDMARK CORPORATION, Versailles, OH (US)

(21) Appl. No.: 11/838,598

(22) Filed: Aug. 14, 2007

(51) Int. Cl. A61G 13/06

(52) U.S. Cl. 119/753; 108/24; 5/606; 5/611

(57) ABSTRACT

A veterinary procedure table includes an animal support member upon which an animal may be placed during the performance of a veterinary procedure. A basin associated with the animal support member is adapted to receive fluid material that may be generated during the performance of the veterinary procedure. The veterinary procedure table further includes a grille associated with the animal support member. The grille includes a frame and a plurality of elongate rods rotatably coupled to the frame. In one embodiment, at least one rod is fixed against rotation.

### TECHNICAL FIELD

The present invention relates to tables for examining and performing procedures on animals, and more particularly to a veterinary procedure table with a grille that facilitates the repositioning of animals thereon.

### BACKGROUND

Veterinary examination and procedure tables are known in the art and are convenient for supporting pets and other animals during examination and treatment. Many veterinary tables have animal support surfaces that are solid, much like a tabletop. Some have perforated surfaces that have a tub or basin positioned beneath the perforated surface. The tub is designed to capture liquids and debris from procedures performed on the table. Thus, the tub collects fluids discharged from the animal during certain procedures, such as cutting and trimming of hair and nails, administering shots, suturing wounds, or performing dental work. The tub may also direct debris and fluids away from the animal support surface to a drain. In any case, the animal support surface remains essentially fluid and debris free.

Veterinarians must sometimes anesthetize the animal prior to treatment. Once the animal is anesthetized, the veterinarian may have difficulty maneuvering the animal. Repositioning may be desired to get access to the treatment site, or to minimize the physical stress on the veterinarian during performance of a procedure. Repositioning is particularly difficult when the veterinarian is working independently or when the animal is large. Therefore, extra time and effort is required to re-position or move the animal to a desired position that enables the veterinarian to perform a procedure.

As is generally known, a person who works in a non-ergonomic position will more quickly tire than a person who is properly positioned with respect to the object on which they are working. For example, a veterinarian who must reach or extend their arms, possibly putting strain on their lower back, will fatigue quickly. Even simple procedures may take longer due to the added physical strain. Consequently, work productivity and service quality may decrease. Thus, the ability to re-position an anesthetized animal is a major factor in efficiently completing treatments. A need, therefore, exists for an improved veterinary procedure table that overcomes these and other drawbacks of the prior art.

### SUMMARY

The present disclosure overcomes the foregoing and other shortcomings and drawbacks of veterinary procedure tables heretofore known for use in examining or treating animals. While the invention will be described in connection with certain embodiments, it will be understood that the invention is not limited to these embodiments. On the contrary, the invention includes all alternative, modifications and equivalents as may be included within the spirit and scope of the invention.

In one aspect, a veterinary procedure table includes an animal support and a basin. The animal support member supports the animal during the performance of a veterinary procedure. The basin is positioned to receive fluids and debris generated during the procedure. A grille for supporting the animal is associated with the animal support member and is positioned in registration with the basin. The grille allows the fluid and debris to pass into the basin. The grille also facilitates positioning or repositioning of the animal such that the veterinarian may more easily access a treatment site.

The grille comprises a frame and a plurality of elongate rods. The elongate rods are rotatably coupled to the frame. The veterinarian may move an anesthetized animal by pushing or pulling the animal along the elongated rods.

In one embodiment, the grille has a support beam joined to the frame. The support beam may make the frame more rigid. In another embodiment, the grille has at least one fixed rod such that the rod does not rotate. In yet another embodiment, the animal support member is vertically adjustable.

### BRIEF DESCRIPTION OF THE FIGURES

The accompanying drawings, which are incorporated in and constitute a part of this specification, illustrate exemplary embodiments of the invention and, together with a general description of the invention given above, and the detailed description given below, serve to explain the invention in sufficient detail to enable one of ordinary skill in the art to which the invention pertains to make and use the invention.

FIG. 1 is a perspective view of an exemplary height-adjustable veterinary procedure table in accordance with the principles of the present disclosure.

FIG. 2 is an exploded view of the veterinary procedure table of FIG. 1, showing one embodiment of a grille.

FIG. 3 is a perspective view of the grille of FIG. 2.

FIG. 4 is a cross-sectional view of the grille of FIG. 3, taken along section line 4-4, illustrating a rectangular tubular frame and a support member.

FIG. 5 is a cross-sectional view of another embodiment of a grille similar to FIG. 4, illustrating a round tubular frame and a support member.

FIG. 6 is a cross-sectional view of a third embodiment of a grille similar to FIGS. 4 and 5, illustrating a solid tubular frame and a solid support member.

FIG. 7 is a cross-sectional view of the grille of FIG. 6, taken along section line 7-7, showing a plurality of elongated rods and a fixed rod.

### DETAILED DESCRIPTION

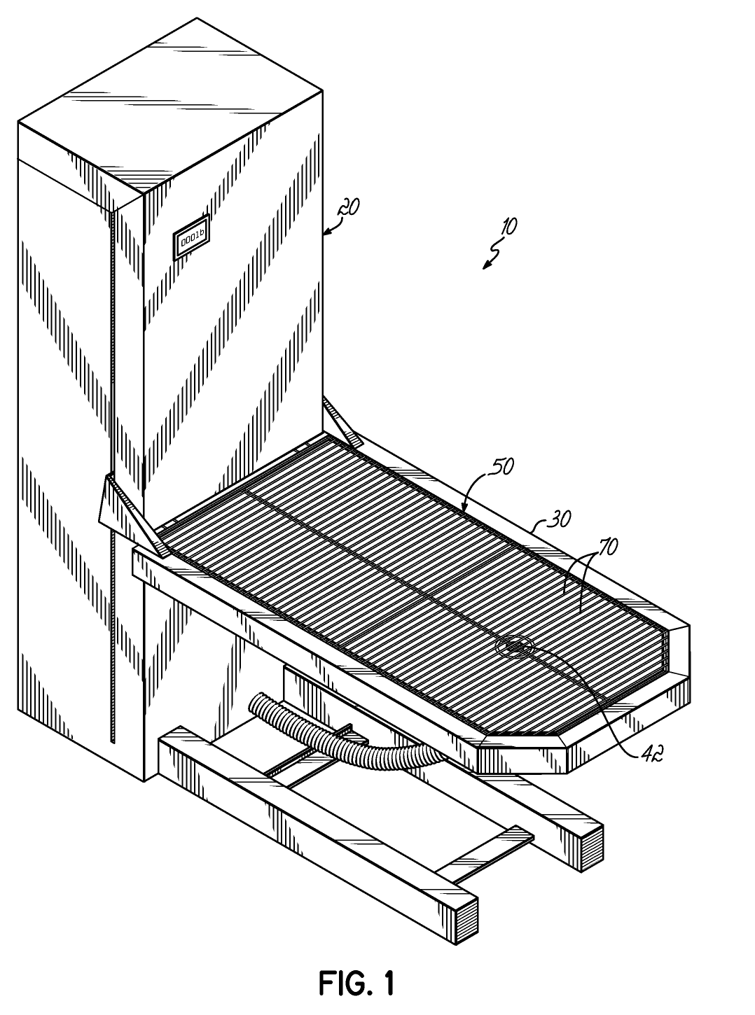

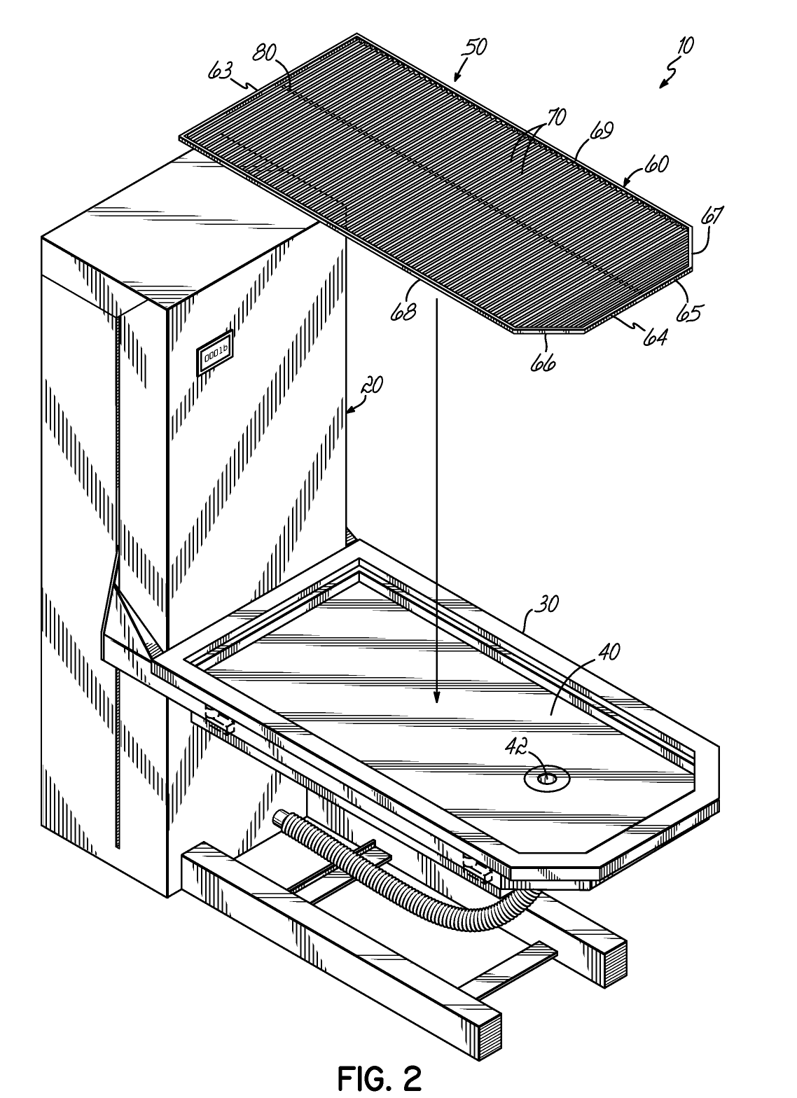

FIGS. 1 and 2 depict an exemplary veterinary procedure table 10 in accordance with the principles of the present disclosure. The veterinary procedure table 10 allows a veterinarian to perform procedures on an animal while directing fluid and debris away from a treatment site. Additionally, the veterinary procedure table 10 permits the veterinarian to laterally position or reposition an animal to facilitate access to the treatment site on the animal. Therefore, the veterinarian may perform procedures with less physical stress by moving the animal on the veterinary procedure table 10 to a position that eases access to the treatment site, as described more fully below. An exemplary veterinary procedure table of this type is shown and described in U.S. Pat. No. 7,073,464, the disclosure of which is hereby incorporated by reference in its entirety.

In one embodiment and with continued reference to FIGS. 1 and 2, the veterinary procedure table 10 comprises a generally vertically oriented base 20 and a cantilevered animal support member 30. The animal support member 30 projects outwardly from the base 20, permitting access to both sides of the animal support member 30 and any animal positioned thereon. The animal support member 30 may be positioned over, or otherwise associated with a basin 40, shown most clearly in FIG. 2. The basin 40 is positioned to receive the fluid and debris generated during the performance of a veterinary procedure. A grille 50 is associated with the animal support member 30 and is positioned in registration with the basin 40. The grille 50 allows the fluid and debris to pass into the basin 40. In one embodiment, the basin 40 has a drain 42 positioned to allow fluid and debris to pass from the basin 40. Thus the treatment area remains substantially free of debris and fluid.

With continued reference to FIG. 2, the grille 50 is removably supported on the animal support member 30. The basin 40 may be therefore periodically and easily cleaned by removing the grille 50. In addition, surgical or other or instruments that may have fallen into the basin 40 may be retrieved simply by removing the grille 50 from over the base 40.

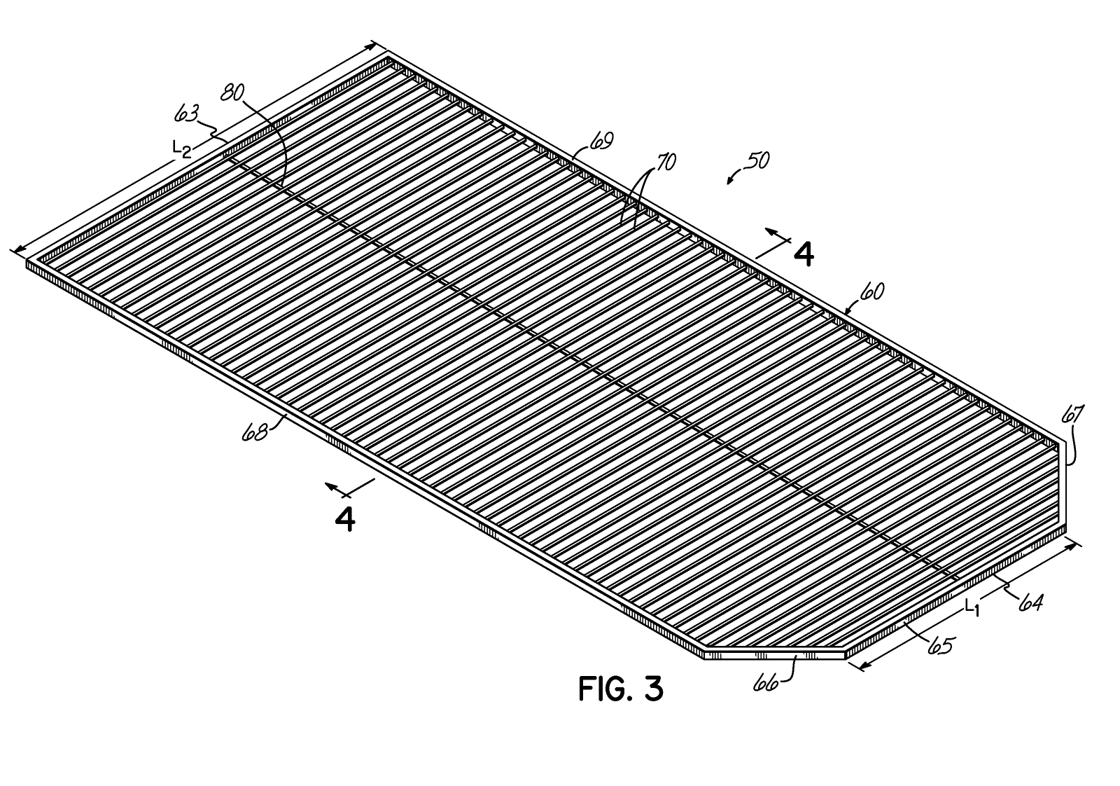

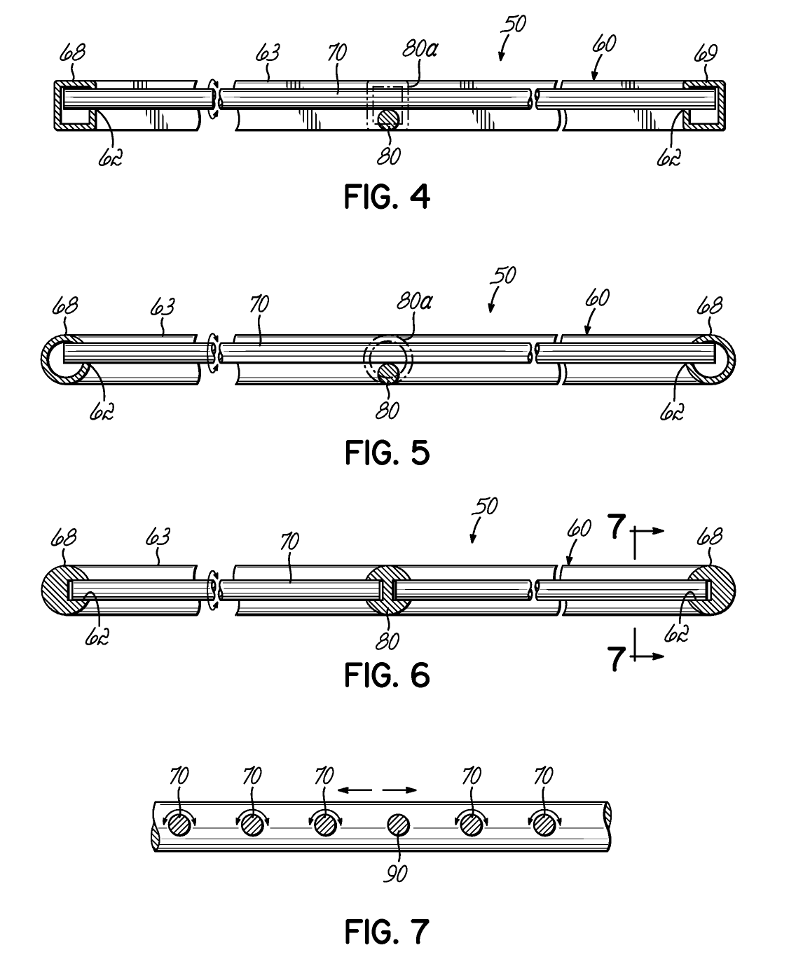

As shown in FIGS. 2 and 3, the grille 50 comprises a frame 60 and a plurality of elongate rods 70. The elongate rods 70 are coupled to the frame 60 such that they rotate about their respective longitudinal axes, as depicted in FIGS. 4-7, for example. In one exemplary embodiment, the elongate rods 70 freely rotate independent of one another. Thus, an animal supported on the grille 50 may be easily moved to various positions on the grille 50, facilitated by the rotation of the elongate rods 70. A veterinarian may move an anesthetized animal by pushing or pulling the animal along the elongated rods 70 to position or reposition the animal. By way of example, and not limitation, the elongate rods 70 may be formed from solid or tubular steel, aluminum, or any other material suitable to support animals on the grille 50. Moreover, the rods 70 may be uniformly shaped and, accordingly, may be cut or sectioned from commercially available bulk material.

With reference now to FIG. 3, the elongate rods 70 may be spaced relative to one another at a distance that facilitates supporting an animal thereon, while permitting fluid and debris to pass between the rods 70. For example, the rods 70 may be spaced to prevent most surgical instruments or equipment from passing between the rods 70 while allowing fluid and debris to pass. In one embodiment, the rods 70 have a diameter of about 3/16 inch and the rods are spaced about 9/16-inch on center. It will be appreciated that various other diameters and spacing of rods may be used. Furthermore, the length of the rods 70 may be uniform or the length of each rod 70 may vary to follow the interior periphery of the frame 60.

As shown in FIGS. 4 and 5, the frame 60 may be hollow with the elongate rods 70 positioned above a center plane of the frame 60. By way of example, as shown in FIG. 4, the frame 60 may be formed from tubing having a rectangular cross section, and, as shown in FIG. 5, the frame 60 may be formed from tubing having a circular cross section. Alternatively, as shown in FIG. 6, the frame 60 may be formed from solid rod or bar stock. The frame 60 may alternatively have other forms or cross sections that facilitate positioning the animal by pushing or pulling the animal across the elongate rods 70. The veterinarian may easily access the animal in an ergonomically friendly posture. One skilled in the art will appreciate that the frame 60 may be assembled, for example, by bending, welding, threading, gluing, or by other various other techniques suitable for forming the frame 60.

As previously described, the rods 70 are rotatably coupled to the frame 60. In one embodiment, as shown in FIGS. 4, 5, and 6, an aperture 62 may be formed in the frame 60, for example, by punching, machining, or otherwise forming a hole into the frame 60. In addition, the aperture 62 may be formed above a center plane of the frame 60, as shown in FIGS. 4 and 5, thereby offsetting the rods 70 to a position closer to an upper surface of the frame 60. In one exemplary embodiment, an outer surface of the rods 70 resides below the upper surface of the frame 60.

With reference now generally to FIGS. 3-7, the grille 50 may have a support beam 80 joined to the frame 60. In the embodiments shown, support beam 80 is oriented transverse to the longitudinal axes of the elongate rods 70, however it will be appreciated that support beam 80 may alternatively be joined to frame 60 in various other configurations. In one exemplary embodiment, the support beam 30 is substantially perpendicular to the longitudinal axis of the rods 70. The support beam 80 may make the frame 60 more rigid or capable of supporting larger animals. The support beam 80 may prevent the elongated rods 70 from substantially deflecting under the weight of the animal, thereby making re-positioning of the animal easier.

FIGS. 4 and 5 illustrate various exemplary cross sections of grille 50 shown in FIG. 3. In the embodiments shown in FIGS. 4 and 5, rods 70 extend fully across the width of the frame 30, and the support beam 80 is positioned directly beneath the elongate rods 70. Alternatively, the rods 70 may pass through the support beam 80a, depicted by phantom lines in FIGS. 4 and 5. Thus, when the animal is positioned on the grille 50, the support beam 80 may be in direct contact with the animal. In addition to orientation and position, the support beam 80 may have a variety of configurations. For example, the support beam may be a solid, circular material thus having a cross section, such as the cross sections shown in FIGS. 4-6 (the support beam designated 80); the support beam may be circular tubing, such as that shown in FIG. 5 (the support beam drawn in phantom lines and designated 80a); the support beam may be rectangular tubing, such as that shown in FIG. 4 (the support beam designated 80a), or the support beam 80 may be other shapes of both solid or tubular material known in the art.

Another exemplary embodiment of the grille 50 is shown in FIG. 6. The elongate rods 70 in this embodiment are rotatably coupled to the frame 60 at one end and to the support beam 80 at the other end. In FIG. 6, two rows of elongate rods 70 are utilized, doubling the number of rods 70. However, additional elongate rods and support beams 80 are possible. The frame 60 may therefore comprise multiple support beams 80. By way of example, the elongate rods 70 may be rotatably coupled to a first support beam (not shown) at one end and a second support beam (not shown) at the other end. While in the embodiments shown, the rods 70 are rotatably coupled to beam 80 by insertion of the end of rod 70 into an aperture 62, it will be appreciated that there are various other ways of rotatably coupling the elongate rods 70 to the frame 60.

With reference once again to FIG. 3, while the frame 60 has a periphery that is depicted as having a generally rectangular shape, it will be appreciated that various other configurations may be used. In the embodiment shown, the frame 60 has one end configured to ease access to the animal. As shown in FIG. 3, the frame 60 has a generally rectangular shape with a proximal end 63, a distal end 64, and opposing sides 68, 69. The distal end 64 of the grille 50 has a length L1 that is shorter than a length L2 of proximal end 63. Two angled side portions 66, 67 extend obliquely from distal end 64 and connect the distal end 64 to the two opposing sides 68, 69. The angled side portions 66, 67 reduce the distance from the periphery to the center of the grille 50, compared to a grille having a 90° corner. Therefore, veterinarians requiring access to a treatment site at the distal end 64 may access the animal while maintaining a more relaxed, ergonomic body position, including while being seated. Consequently, the veterinarian may not fatigue as quickly. If the veterinarian is performing, for example, a dental treatment on an animal and the animal's head is positioned at the distal end 64 of the grille 50, the veterinarian will have to reach from the edge, towards the center of the grille 50. Overall, work productivity may improve due to less physical stress on the veterinarian. In summary, the elongate rods 70 and the angled side portions 66, 67 may create an ergonomically enhanced environment for the veterinarian.

While angled side portions 66, 67 are shown, it will be appreciated that grille 50 may have various other configurations to facilitate access to treatment sites positioned in the center of the grille 50. For example, the angled side portions 66, 67 may form a more rounded end distal 64.

In another exemplary embodiment, as depicted in FIG. 7, at least one rod 90 is fixed against rotation. The fixed rod 90 may therefore provide lateral rigidity to the grille 50. The fixed rod 90 may be interspersed between one or more of the rotable rods 70. In one embodiment, the ratio of the number of fixed rods 90 to a number of elongated rods 70 is five to one, as shown in FIG. 7, although more or fewer fixed rods 90 may be present.

The animal support member 30 may also be vertically adjustable. Thus, the animal support member 30 and the grille 50 may be lowered near the ground to facilitate placing or guiding an animal onto the grille 50. In other cases, where the animal is anesthetized first, the veterinarian may transfer of the animal from a gurney. For example, the animal support member 30 may be adjusted to the height of the gurney. The veterinarian may then slide the animal onto the grille 50. Once the animal is positioned on the grille 50, the support member 30 may be raised or lowered such that the veterinarian may work at a convenient position, such as standing up or sitting down.

While the present invention has been illustrated by the description of one or more embodiments thereof, and while the embodiments have been described in considerable detail, they are not intended to restrict or in any way limit the scope of the appended claims to such detail. The various features discussed herein may be utilized alone or in any combination. Additional advantages and modifications will readily appear to those skilled in the art. The invention is therefore not limited to the specific details, representative apparatus and process and illustrative examples shown and described. Accordingly, departures may be made from such details without departing from the scope of the general inventive concept.

What is claimed is:

1. A grille for supporting an animal on a veterinary procedure table having an animal support member and a basin for receiving fluids generated during the performance of a procedure, the grille comprising:
a frame adapted to be removably supported on the animal support member in registration with the basin; and
a plurality of first elongate rods coupled to the frame for rotation about respective longitudinal axes of the elongate rods.

2. The grille of claim 1 wherein the frame has an upper surface and the outer surface of the first rods reside below the upper surface of the frame.

3. The grille of claim 1 wherein the first rods are spaced about 9/16 inch on center.

4. The grille of claim 1 wherein the frame has at least two opposing sides and further includes a support beam joining opposing sides of the frame.

5. The grille of claim 4 wherein the support beam is positioned under the first rods.

6. The grille of claim 4 wherein the first rods extend between opposing sides of the frame and pass through the support beam.

7. The grille of claim 4 wherein the first rods have one end coupled to the frame and an opposite end coupled to the support beam for rotation about respective longitudinal axes.

8. The grille of claim 1 further comprising at least one elongate second rod, the second rod being parallel to the first rods and fixed against rotation about a longitudinal axis of the second rod.

9. The grille of claim 8 comprising a plurality of second rods, the second rods interspersed between one or more first rods.

10. The grille of claim 1 wherein the frame has a proximal end, a distal end, and two opposing sides, and wherein the proximal end connects the opposing sides, and the distal end has a length that is less than a length of the proximal end with the distal end connected to the opposing sides by two angled side portions.

11. A veterinary procedure table comprising:
a base;
an animal support member operatively coupled to the base;
a basin associated with the animal support member, the basin adapted to receive fluids generated during the performance of a procedure; and
a grille comprising a frame and a plurality of elongate first rods, wherein the frame is adapted to be removably supported on the animal support member in registration with the basin, and the first rods are coupled to the frame and are adapted to rotate about their respective longitudinal axes.

12. The veterinary procedure table of claim 11 wherein the animal support member is adjustable to vary a height of the animal support member relative to a ground surface.

13. The veterinary procedure table of claim 11 wherein the first rods are spaced about 3/16 inch on center.

14. The veterinary procedure table of claim 11 wherein the frame has at least two opposing sides, and further including a support beam extending between opposing sides of the frame.

15. The veterinary procedure table of claim 14 wherein the support beam is positioned under the first rods.

16. The veterinary procedure table of claim 14 wherein the first rods extend between opposing sides of the frame and pass through the support beam.

17. The veterinary procedure table of claim 14 wherein the first rods have one end coupled to the frame and an opposite end coupled to the support beam for rotation about respective longitudinal axes.

18. The veterinary procedure table of claim 11 further comprising at least one elongate second rod, the second rod being parallel to the first rods and fixed against rotation about its longitudinal axis.

19. The veterinary procedure table of claim 18 comprising a plurality of second rods, the second rods interspersed between one or more first rods.
